(19) United States
(12) Patent Application Publication
(10) Pub. No.: US 2009/0021337 A1
(43) Pub. Date: Jan. 22, 2009

(54) MULTILAYER COMPOSITE ELECTRONIC COMPONENT

(75) Inventor: Takahiro SATO, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/169,352

(22) Filed: Jul. 8, 2008

(30) Foreign Application Priority Data
Jul. 20, 2007 (JP) 2007-189887

(51) Int. Cl. H01F 27/34

(52) U.S. Cl. 336/234

(57) ABSTRACT

A multilayer composite electronic component is provided with an inductor section and a varistor section. The inductor section has a first sintered body consisting of a stack of nonmagnetic layers, and coil conductors arranged in the first sintered body. The varistor section has a second sintered body consisting of a stack of varistor layers, hot electrodes, and ground electrodes. The first sintered body and the second sintered body are integrally fired. A region of the first sintered body sandwiched between the coil conductors and regions of the first sintered body inside the respective coil conductors are comprised of a magnetic material or a nonmagnetic material and contain a ferrite material containing a Cu component in an amount of 0.05 mol % to 2 mol % in terms of CuO.

### BACKGROUND OF THE INVENTION

1. Field of the Invention

The present invention relates to a multilayer composite electronic component having an inductor section and a varistor section laid on the inductor section.

2. Related Background Art

In recent years, a noise filter with a surge protection function is used as an EMC component in various electronic devices. Patent Document 1 (See for Japanese Patent No. 2626143) discloses a multilayer composite electronic component consisting of a stack of a magnetic layer with a predetermined conductor pattern inside and a varistor layer with a predetermined conductor pattern inside, wherein the magnetic layer and the varistor layer are electrically connected through a through-hole.

### SUMMARY OF THE INVENTION

The foregoing Patent Document 1 discloses a Ni—Cu—Zn ferrite as a material for the magnetic layer, and it was found by inventors' research that when the layer of the Ni—Cu—Zn ferrite was integrally fired with the varistor layer, the Cu component diffused into the varistor layer to degrade its varistor function, particularly, immunity to ESD (ElectroStatic Discharge) (which will be referred to hereinafter as “ESD immunity”).

An object of the present invention is therefore to provide a multilayer composite electronic component free of the deterioration of the varistor function and, particularly, free of the deterioration of the ESD immunity.

The inventors conducted extensive and intensive research on material compositions used for the layer to be integrally fired with the varistor layer, and found that use of a ferrite material containing a specific amount of Cu prevented deterioration of characteristics of the varistor section and achieved good filter characteristics, thereby accomplishing the present invention.

Specifically, a multilayer composite electronic component according to the present invention is a multilayer composite electronic component comprising: an inductor section having a first sintered body and a plurality of coil conductors arranged in the first sintered body; and a varistor section having a second sintered body and a plurality of internal electrodes arranged in the second sintered body, and exhibiting a nonlinear current-voltage characteristic; wherein the first sintered body and the second sintered body are integrally fired; and wherein a region of the first sintered body sandwiched between the coil conductors and a region of the first sintered body inside each coil conductor are comprised of a magnetic material or a nonmagnetic material, and comprise a ferrite material containing a Cu component in an amount of 0.05 mol % to 2 mol % in terms of CuO.

According to the present invention, the region of the first sintered body sandwiched between the coil conductors comprises the ferrite material containing the Cu component in the amount of 0.05 mol % to 2 mol % in terms of CuO, and even after it is integrally fired with the second sintered body of the varistor section, an amount of the Cu component present in the second sintered body is extremely small. Therefore, the deterioration of the varistor function is suppressed.

The multilayer composite electronic component of the present invention is preferably configured as follows: the ferrite material is a Ni—Zn ferrite, a Ni—Zn—Mg ferrite, or a Zn ferrite. According to the present invention, the ferrite material in the inductor section is the Ni—Zn ferrite, the Ni—Zn—Mg ferrite, or the Zn ferrite. Particularly, when the ferrite material is the Ni—Zn ferrite or the Ni—Zn—Mg ferrite, the inductor section has a high inductance value and the multilayer composite electronic component can be obtained with excellent filter characteristics.

The multilayer composite electronic component of the present invention is preferably configured as follows: each coil conductor consists of a plurality of conductor patterns arranged in a first direction; the first sintered body has a first layer sandwiched by the conductor patterns in the first direction, and second layers sandwiching the plurality of coil conductors in the first direction; the first layer is comprised of a nonmagnetic material; the second layers are comprised of a magnetic material. Since in this multilayer composite electronic component the second layers of the magnetic material are laid on either side of the first layer sandwiched by the conductor patterns and comprised of the nonmagnetic material, a frequency band to ensure a satisfactory inductance value of the coil conductors can be enhanced to a relatively high frequency region. Therefore, the multilayer composite electronic component is obtained with better filter characteristics.

The multilayer composite electronic component of the present invention is preferably configured as follows: each coil conductor consists of a plurality of conductor patterns arranged in a first direction; the first sintered body has a first layer sandwiched by the conductor patterns in the first direction, and second layers sandwiching the plurality of coil conductors in the first direction; the first and second layers are comprised of a magnetic material. Since in this multilayer composite electronic component the second layers also comprised of the magnetic material are laid on either side of the first layer sandwiched by the conductor patterns and comprised of the magnetic material, the inductance value of the coil conductors becomes much higher in a lower frequency region than in the electronic component wherein the first layer is comprised of the nonmagnetic material and wherein the second layers are comprised of the magnetic material.

The multilayer composite electronic component of the present invention is preferably configured as follows: each coil conductor consists of a plurality of conductor patterns arranged in a first direction; the first sintered body has a first layer sandwiched by the conductor patterns in the first direction, and second layers sandwiching the plurality of coil conductors in the first direction; the first and second layers are comprised of a nonmagnetic material. Since in this multilayer composite electronic component the second layers also comprised of the nonmagnetic material are laid on either side of the first layer sandwiched by the conductor patterns and comprised of the nonmagnetic material, the frequency band to ensure a satisfactory inductance value of the coil conductors can be further enhanced to a higher frequency region than in the electronic component wherein the first layer is comprised of the nonmagnetic material and wherein the second layers are comprised of the magnetic material. Therefore, the multilayer composite electronic component is obtained with better filter characteristics.

The present invention successfully provides the multilayer composite electronic component free of the deterioration of the varistor function and, particularly, free of the deterioration of the ESD immunity.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view showing a multilayer composite electronic component according to the first embodiment.

FIG. 2 is an exploded perspective view showing the multilayer composite electronic component according to the first embodiment.

FIG. 3 is a drawing showing an equivalent circuit of the multilayer composite electronic component according to the first embodiment.

### DESCRIPTION OF THE PREFERRED EMBODIMENTS

The expertise of the present invention can be readily understood in view of the following detailed description with reference to the accompanying drawings which are presented by way of illustration only. Embodiments of the present invention will be described below with reference to the accompanying drawings. The same portions will be denoted by the same reference symbols as much as possible, without redundant description. It is noted that the terms “upper” and “lower” will be used in the description and they correspond to upper and lower locations in each drawing.

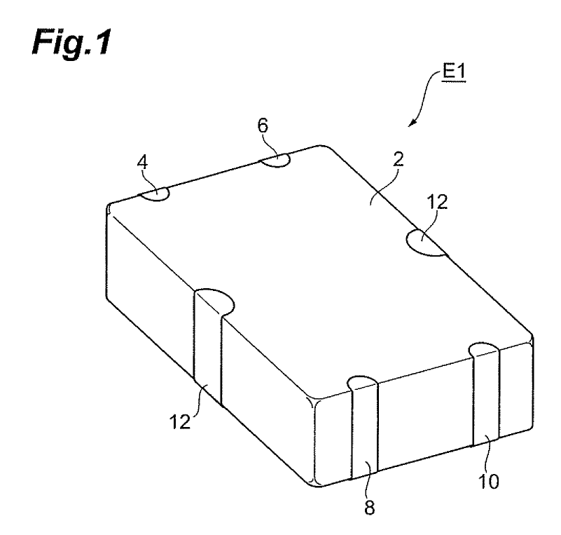

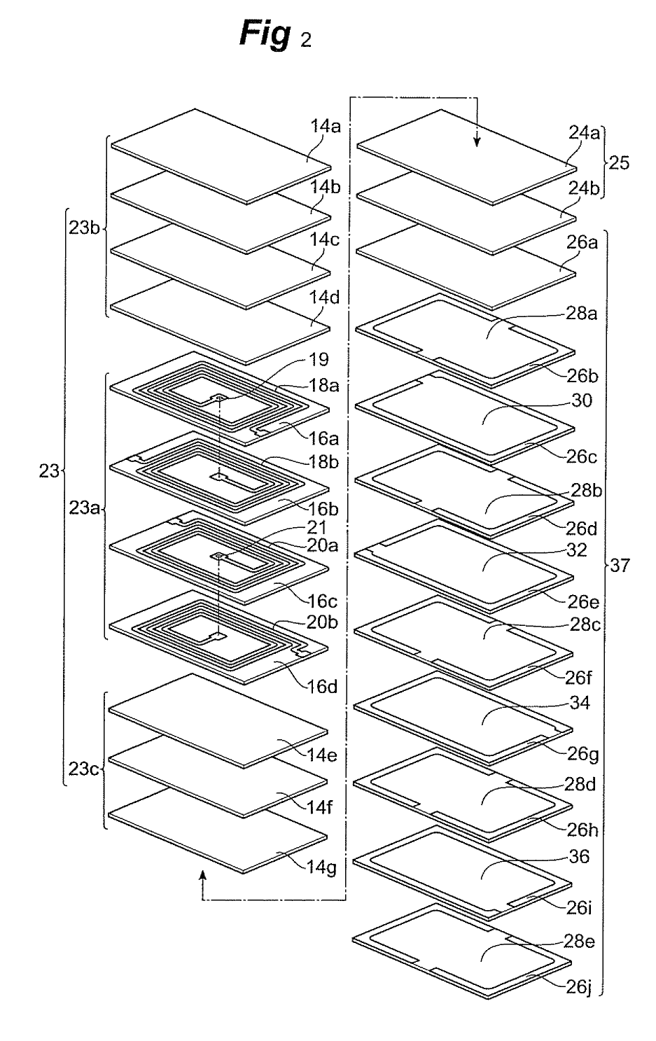

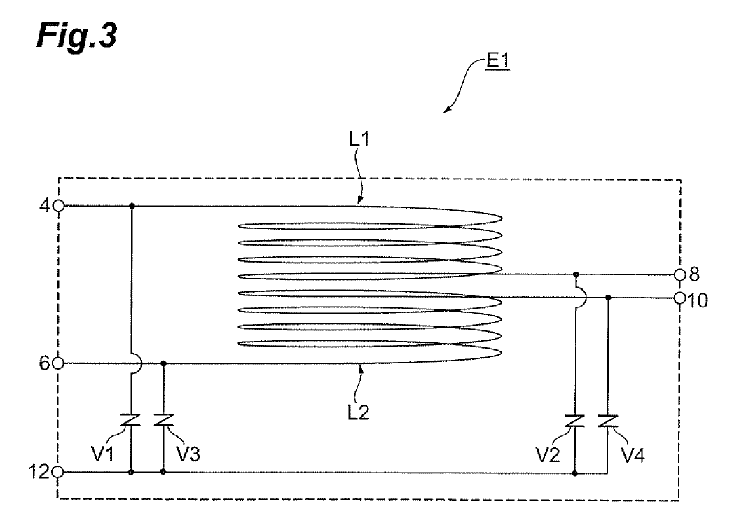

FIG. 1 is a perspective view of the multilayer composite electronic component according to an embodiment of the present invention. FIG. 2 is an exploded perspective view of the multilayer composite electronic component according to the present embodiment. FIG. 3 is a drawing showing an equivalent circuit of the multilayer composite electronic component according to the present embodiment.

The multilayer composite electronic component E1 of the present embodiment (which will be referred to hereinafter as a multilayer electronic component E1) is an application of the present invention to a multilayer electronic component with the common mode filter function and varistor function. As shown in FIG. 1, the multilayer electronic component E1 is provided with an element body 2 of a nearly rectangular parallelepiped shape. Input terminal electrodes 4, 6 are formed at one end of the element body 2 in the longitudinal direction and output terminal electrodes 8, 10 at the other end of the element body 2 in the longitudinal direction. A pair of ground terminal electrodes 12 are formed on two side faces of the element body 2 in the longitudinal direction.

The element body 2 of the multilayer electronic component E1, as shown in FIG. 2, has an inductor section 23, an intermediate section 25 consisting of a stack of insulating layers 24a, 24b, and a varistor section 37. As shown in FIG. 3, the multilayer electronic component E1 is provided with a plurality of coils L1, L2 (two coils in the present embodiment) constituting a common mode choke coil, and a plurality of varistors V1-V4 (four varistors in the present embodiment), and these constitute a π type circuit.

The inductor section 23 has a first sintered body and a plurality of coil conductors 18, 20. The first sintered body is a portion consisting of a stack of nonmagnetic layers 14a-14g, 16a-16d, and is integrally fired with the intermediate section 25 and a second sintered body of the varistor section 37. The plurality of coil conductors 18, 20 are arranged between the nonmagnetic layers 14a-14g, 16a-16d, or in the first sintered body.

The first sintered body has a first layer 23a and second layers 23b, 23c. The first layer 23a is a portion sandwiched by the conductor patterns 18a, 18b, 20a, 20b in the stack direction (first direction) of the nonmagnetic layers 14a-14g, 16a-16d.

More specifically, the first layer 23a includes the nonmagnetic layers 16a-16d on which the conductor patterns 18a, 18b, 20a, 20b are formed. The conductor pattern 18a is formed on the nonmagnetic layer 16a, and the conductor pattern 18b is formed on the nonmagnetic layer 16b. The conductor patterns 18a, 18b are formed in a spiral shape from the center to the edge. An end of the conductor pattern 18a located at the edge is drawn out to an end face of the nonmagnetic layer 16a so as to be connectable to the output terminal electrode 8. An end of the conductor pattern 18b located at the edge is drawn out to an end face of the nonmagnetic layer 16b so as to be connectable to the input terminal electrode 4. The other end of the conductor pattern 18a and the other end of the conductor pattern 18b are electrically connected through a via conductor 19 formed in the nonmagnetic layer 16a. The conductor patterns 18a, 18b constitute a coil conductor 18 and this coil conductor 18 corresponds to the coil L1 shown in FIG. 3.

The conductor pattern 20a is formed on the nonmagnetic layer 16c and the conductor pattern 20b is formed on the nonmagnetic layer 16d. The conductor patterns 20a, 20b are formed in a spiral shape from the center to the edge. An end of the conductor pattern 20a located at the edge is drawn out to an end face of the nonmagnetic layer 16c so as to be connectable to the input terminal electrode 6. An end of the conductor pattern 20b located at the edge is drawn out to an end face of the nonmagnetic layer 16d so as to be connectable to the output terminal electrode 10. The other end of the conductor pattern 20a and the other end of the conductor pattern 20b are electrically connected through a via conductor 21 formed in the nonmagnetic layer 16c. The conductor patterns 20a, 20b constitute a coil conductor 20 and this coil conductor 20 corresponds to the coil L2 shown in FIG. 3.

The second layers 23b, 23c are portions sandwiching the coil conductors 18, 20 in the stack direction of the nonmagnetic layers 14a-14g, 16a-16d. More specifically, the second layer 23b is located on the upper side of the first layer 23a and consists of nonmagnetic layers 14a-14d with no conductor pattern formed thereon. The second layer 23c is located on the lower side of the first layer 23a and consists of nonmagnetic layers 14e-14g with no conductor pattern formed thereon. The nonmagnetic layer 16d is included in the first layer 23a in the present embodiment, but it may be included in the second layer 23c, instead of the first layer 23a.

The nonmagnetic layers 14a-14g, 16a-16d are comprised of a nonmagnetic material and contain a ferrite material containing a Cu component in an amount of 0.05 mol % to 2 mol % in terms of CuO. Since the nonmagnetic layers 16a-16d are made as described above, the region sandwiched by the conductor patterns 18a, 18b and the conductor patterns 20a, 20b, i.e., the region sandwiched by the coil conductor 18 and the coil conductor 20, is comprised of the nonmagnetic material and contains the ferrite material containing the Cu component in the amount of 0.05 mol % to 2 mol % in terms of CuO. The regions located inside the conductor patterns 18a, 18b and the regions located inside the conductor patterns 20a, 20b, i.e., the regions located inside the respective coil conductors 18, 20, are also comprised of the nomnagnetic material and contain the ferrite material containing the Cu component in the amount of 0.05 mol % to 2 mol % in terms of CuO.

If the amount of the Cu component is too small in the region sandwiched by the coil conductors 18, 20 and in the regions located inside the respective coil conductors 18, 20, the specific resistance will become lowered and it will result in failing to achieve satisfactory performance as a common mode filter. On the other hand, if the amount of the Cu component is too large there, the Cu component will diffuse into the varistor section 37 during the integral firing of the first sintered body of the inductor section 23 and the second sintered body of the varistor section 37 and it will result in deteriorating the varistor function. Particularly, an increase in the Cu component in varistor layers 26b-26i (which will be detailed later) to exhibit the varistor characteristics will lead to deterioration of the ESD immunity and it is thus necessary to minimize the amount of the Cu component in the nonmagnetic layers 14a-14g, 16a-16d. From this viewpoint, the nonmagnetic layers 14a-14g, 16a-16d more preferably contain the ferrite material containing the Cu component in an amount of 0.1 mol % to 1 mol % in terms of CuO. The ferrite material is preferably a Zn ferrite in the nonmagnetic layers 14a-14g, 16a-16d.

An electroconductive material used for the conductor patterns 18a, 18b, 20a, 20b and the via conductors 19, 21 is a metal material that can be simultaneously fired with the nonmagnetic layers 14a-14g, 16a-16d. Namely, since the firing temperature of ferrite is normally approximately 800° C.-1400° C., the metal material to be used is one not melting at the temperature. For example, suitably applicable materials include Ag, Pd, alloys thereof, and so on.

The element body 2 has the varistor section 37 to exhibit the nonlinear current-voltage characteristic. The varistor section 37 has a second sintered body, a hot electrode 30, and ground electodes 28a, 28b (a plurality of internal electrodes). The second sintered body is a portion consisting of a stack of varistor layers 26a-26j. The hot electrode 30 and the ground electrodes 28a, 28b are arranged between the varistor layers 26a-26j, or in the second sintered body.

The plurality of varistor layers 26a-26j are stacked in this order from top. The ground electrodes 28a-28e of a nearly rectangular shape electrically connected to the ground terminal electrodes 12 are formed on the respective varistor layers 26b, 26d, 26f, 26h, and 26j. The hot electrode 30 of a nearly rectangular shape electrically connected to the input terminal electrode 6 is formed on the varistor layer 26c and a hot electrode 32 of a nearly rectangular shape electrically connected to the input terminal electrode 4 is formed on the varistor layer 26e. A hot electrode 34 of a nearly rectangular shape electrically connected to the output terminal electrode 10 is formed on the varistor layer 26g, and a hot electrode 36 of a nearly rectangular shape electrically connected to the output terminal electrode 8 is formed on the varistor layer 26i.

The hot electrode 30 and the ground electrodes 28a, 28b are opposed as overlapping in part through the varistor layers 26b, 26c when viewed from the stack direction, whereby the varistor V3 shown in FIG. 3 is formed in the varistor section 37. The hot electrode 32 and the ground electrodes 28b, 28c are opposed as overlapping in part through the varistor layers 26d, 26e when viewed from the stack direction, whereby the varistor V1 shown in FIG. 3 is formed in the varistor section 37. The hot electrode 34 and the ground electrodes 28c, 28d are opposed as overlapping in part through the varistor layers 26f, 26g when viewed from the stack direction, whereby the varistor V4 shown in FIG. 3 is formed in the varistor section 37. The hot electrode 36 and the ground electrodes 28d, 28e are opposed as overlapping in part through the varistor layers 26h, 26i when viewed from the stack direction, whereby the varistor V2 shown in FIG. 3 is formed in the varistor section 37. In this manner; the hot electrodes 30, 32, 34, 36 and the ground electrodes 28a-28e are opposed as overlapping in part through the varistor layers 26b-26i when viewed from the stack direction, whereby the four varistors V1-V4 are formed in the varistor section 37.

The varistor layers 26a-26j are made, for example, of a ceramic material containing ZnO as a main component. This ceramic material may contain Pr, Bi, Co, Al, etc. as additive components, When the ceramic material contains Co in addition to Pr, the varistor section has excellent varistor characteristics and high electric permittivity (ε). When the ceramic material further contains Al, the varistor section comes to have low resistance. The ceramic material may further contain another additive according to need, e.g., such elements as Cr, Ca, Si, and K.

An electroconductive material used for the ground electrodes 28a-28e and the hot electrodes 30, 32, 34, 36 is a metal material that can be simultaneously fired with the ceramic material forming the varistor layers 26a-26j. Namely, since the firing temperature of varistor ceramics is normally approximately 800° C.-1400° C., the metal material to be used is one not melting at the temperature. For example, suitably applicable materials include Ag, Pd, alloys thereof, and so on.

The element body 2 has the intermediate section 25. The intermediate section 25 is located between the inductor section 23 and the varistor section 37, and consists of insulting layers 24a, 24b. The intermediate section 25 is a portion provided for adjusting shrinkage rates of the inductor section 23 and the varistor section 37. When the intermediate section 25 is provided, it becomes feasible to more reliably prevent the Cu component from diffusing from the inductor section 23 into the varistor section 37. The insulting layers 24a, 24b are made, for example, of a ceramic material containing ZnO and Fe₂O₃ as main components.

The following will describe a method of producing the above-described multilayer electronic component E1.

A nonmagnetic slurry is first prepared by mixing a nonmagnetic raw powder which will form the nonmagnetic layers 14a-14g, 16a-16d after fired, with an organic vehicle containing an organic solvent and an organic binder. The nonmagnetic raw powder to be used is a raw powder that becomes a ferrite containing a Cu component in an amount of 0.5 mol % to 2 mol % in terms of CuO after the inductor section 23 and the varistor section 37 are integrally fired. Preferably, the raw powder to be used is one that becomes a ferrite containing the Cu component in an amount of 0.1 mol % to 1 mol % in terms of CuO after the integral firing.

There are no particular restrictions on the form of the nonmagnetic raw powder as long as it becomes the ferrite containing the predetermined amount of the Cu component after the integral firing. For example, the nonmagnetic raw powder can be a mixture of predetermined amounts of a CuO powder and a ferrite powder. It is also possible to use a ferrite powder obtained by preliminarily firing a ferrite containing a predetermined amount of the Cu component and pulverizing the resultant, or a mixture of raw-material oxides, such as iron oxide and zinc oxide, and others to become a ferrite after fired.

The ferrite is preferably a Zn ferrite. When such a ferrite is used, a high inductance value is achieved and thus good filter characteristics are achieved.

Next, the nonmagnetic slurry is applied onto a PET (polyethylene terephthalate) film by the doctor blade method or the like, to form nonmagnetic green sheets, for example, in the thickness of about 20 μm.

Thereafter, a through-hole is formed at the desired position of each required nonmagnetic green sheet, i.e., at the predetermined position where the aforementioned via conductor 19, 21 is to be formed. The through-hole can be formed by a laser processing machine or the like.

Subsequently, the conductor patterns 18a, 18b, 20a, 20b are formed on the respective nonmagnetic green sheets by the screen printing method or the like. The via conductors 19, 21 are also formed by filling the through-holes formed in the respective nonmagnetic green sheets, with an electroconductive paste. The electroconductive paste to be used for the printing or the like of the conductor patterns 18a, 18b, 20a, 20b and the via conductors 19, 21 can be one containing Ag, Pd, an alloy thereof, or the like as a main component.

Subsequently, a varistor slurry is prepared by mixing a varistor raw powder which will form the varistor layers 26a-26j after fired, with an organic vehicle containing an organic solvent and an organic binder. There are no particular restrictions on the form of the varistor raw powder as long as it can form the varistors in a predetermined composition after the integral firing. The varistor raw powder to be used can be a mixed powder containing ZnO as a main component and predetermined amounts of various metal compounds as additives, e.g., Pr₆O₁₁, CoO, Cr₂O₃, CaCO₃, SiO₂, K₂CO₃, and Al₂O₃. It is also possible to use a varistor powder obtained by preliminarily firing a varistor ceramic of a predetermined composition and pulverizing the resultant.

Next, the varistor slurry is applied onto a PET film by the doctor blade method or the like, to form varistor green sheets, for example, in the thickness of about 30 μm.

Next, an electroconductive paste is used to form the hot electrodes and ground electrodes on the varistor green sheets by the screen printing method or the like. The electroconductive paste to be used can be one containing Ag, Pd, or an alloy thereof as a main component.

Subsequently, an insulator slurry is prepared by mixing an insulator raw powder which will form the insulating layers 24a, 24b after fired, with an organic vehicle containing an organic solvent and an organic binder. The insulator raw powder to be used can be, for example, a mixed powder of ZnO and Fe₂O₃ as main components. The insulator slurry thus prepared is applied onto a PET film by the doctor blade method or the like, to form insulator green sheets, for example, in the thickness of about 30 μm.

Next, the nonmagnetic green sheets with the conductor patterns 18a, 18b, 20a, 20b of the predetermined shapes and the via conductors 19, 21, the nonmagnetic green sheets with neither the conductor pattern nor the via conductor, the varistor green sheets with the hot electrode 30, 32, 34, 36 or the ground electrode 28a-28e, the varistor green sheets with neither the hot electrode nor the ground electrode, and the insulator green sheets are stacked in order as shown in FIG. 2, pressed, and cut into a predetermined shape to obtain a green laminate. Thereafter, the green laminate is fired under predetermined conditions (e.g., 1100° C.-1200° C. in air), to obtain the element body 2. Since little diffusion of the Cu component occurs into the varistor section 37 in the resultant element body 2, good varistor characteristics are achieved.

Thereafter, an electroconductive paste is applied onto the longitudinal ends of the element body 2 and the central regions in the longitudinal direction on the two side faces thereof and the element body 2 with the electroconductive paste is thermally treated under predetermined conditions (e.g., 700° C.-800° C. in air) to bake the terminal electrodes. The electroconductive paste to be used can be one containing a powder containing Ag as a main component. Thereafter, the surfaces of the terminal electrodes are plated to obtain the multilayer electronic component E1 with the input terminal electrodes 4, 6, the output terminal electrodes 8, 10, and the ground terminal electrodes 12. The plating is preferably electrolytic plating and materials used for the plating can be, for example, Ni/Sn, Cu/Ni/Sn, Ni/Pd/Au, Ni/Pd/Ag, Ni/Ag, and so on.

In the present embodiment, as described above, the first sintered body consisting of the nonmagnetic layers 14a-14g, 16a-16d is comprised of the ferrite material containing the Cu component in the amount of 0.05 mol % to 2 mol % in terms of CuO. For this reason, even after the first sintered body is integrally fired with the second sintered body of the varistor section 37 consisting of the varistor layers 26a-26j, an amount of the Cu component having diffused into the second sintered body is extremely small and thus the deterioration of the varistor function is well suppressed.

In the present embodiment, the first sintered body of the inductor section 23 has the first layer 23a sandwiched by the conductor patterns 18a, 18b, 20a, 20b in the stack direction of the nonmagnetic layers 14a-14g, 16a-16d, and the second layers 23b, 23c sandwiching the coil conductors 18, 20 in the stack direction. Since the second layers 23b, 23c also comprised of the nonmagnetic material are laid on either side of the first layer 23a comprised of the nonmagnetic material, a frequency band to obtain a satisfactory inductance value by the coil conductors 18, 20 (coils L1, L2) is enhanced to a higher frequency region, whereby the multilayer electronic component E1 is obtained with better filter characteristics.

The above described the preferred embodiments of the multilayer filter and the production method thereof according to the present invention, but it is noted that the present invention is not always limited to the above-described embodiments but can be modified in various ways without departing from the scope of the invention.

For example, the above embodiment showed the configuration in which the layers 16a-16d forming the first layer 23a were the nonmagnetic layers, but all the layers 16a-16d do not have to be made of the nonmagnetic material. Namely, it is sufficient that a predetermined region in each of the layers 16a-16d be made of the nonmagnetic material. More specifically, the regions to be made of the nonmagnetic material among the layers 16a-16d are at least the region sandwiched by the conductor patterns 18a, 18b and the conductor patterns 20a, 20b, the region located inside the conductor patterns 18a, 18b, and the region located inside the conductor patterns 20a, 20b.

The above embodiment showed the configuration wherein the layers 16a-16d forming the first layer 23a and the layers 14a-14g forming the second layers 23b, 23c all were the nonmagnetic layers, but it is also possible to adopt a configuration wherein the layers 14a-14g are magnetic layers and wherein the layers 16a-16d are nonmagnetic layers. It is also possible to adopt a configuration wherein all the layers 14a-14g, 16a-16d are magnetic layers. When they are magnetic layers, the ferrite material to be used is preferably a Ni—Zn ferrite or a Ni—Zn—Mg ferrite. In this case, the ferrite material also contains the Cu component in the amount of 0.05 mol % to 2 mol % in terms of CuO. When such a ferrite material is used for the layers 14a-14g, 16a-16d, the coil conductors 18, 20 (coils L1, L2) come to have a high inductance value and excellent filter characteristics are achieved accordingly.

The above embodiment showed the configuration provided with the two coil conductors (coils), but the number of coil conductors (coils) does not have to be limited to it. Furthermore, the above embodiment showed the configuration of the common mode choke coil composed of the coil conductors (coils), but it is also possible to constitute a transformer.

### Example 1

A nonmagetic raw powder was first prepared by mixing a Zn ferrite powder with a CuO powder weighed so that the content of the Cu component was 0.05 mol %, and this raw powder was mixed with an organic vehicle to prepare a nonmagnetic slurry.

The resultant nonmagnetic slurry was applied onto a PET film by the doctor blade method to produce nonmagnetic green sheets in the thickness of 20 μm. Thereafter, a through-hole is formed at a predetermined position on the required nonmagnetic green sheets with a laser processing machine, and an electroconductive paste containing Pd as a main component was used to form the conductor patterns of the predetermined shapes and the via conductors in the through-holes by the screen printing method, thereby producing green sheets for formation of the first layer.

Next, a varistor slurry was prepared by mixing a varistor raw powder as a mixture of predetermined amounts of ZnO, Pr₆O₁₁, CoO, Cr₂O₃, CaCO₃, SiO₂, K₂CO₃, and Al₂O₃, with an organic vehicle.

This varistor slurry was applied onto a PET film by the doctor blade method to produce varistor green sheets in the thickness of 30 μm. Thereafter, an electroconductive paste containing Pd as a main component was applied onto the varistor green sheets by the screen printing method to form the electrodes in the predetermined patterns, thereby forming green sheets for formation of the varistor layers.

Next, an insulator slurry was prepared by mixing a mixed powder of ZnO and Fe₂O₃ as main components, with an organic vehicle. This insulator slurry was applied onto a PET film by the doctor blade method to produce insulator green sheets in the thickness of 30 μm.

Subsequently, the green sheets for formation of the first layer, the green sheets for formation of the varistor layers, the nonmagnetic green sheets with no conductor pattern printed, the varistor sheets with no conductor pattern printed, and the insulator green sheets were prepared and stacked in the order shown in FIG. 2, to produce a green laminate. This green laminate was so cut as to obtain a rectangular parallelepiped 2.0 mm long, 1.2 mm wide, and 1.0 mm thick after fired, and then the green laminate was fired at 1100° C.-1200° C. in air to produce an element body. Thereafter, an electroconductive paste containing silver as a main component was applied onto ends of the element body, the element body was fired at 700° C.-800° C. in air to bake the terminal electrodes, and the terminal electrodes were further electroplated with Ni/Sn (in the order of Ni and Sn) to produce a multilayer electronic component.

### Example 2

A multilayer electronic component was produced in the same manner as in Example 1, except that the nonmagnetic raw powder used was a mixture of a Zn ferrite powder and a CuO powder weighed so that the content of the Cu component was 0.1 mol %.

### Example 3

A multilayer electronic component was produced in the same manner as in Example 1, except that the nonmagnetic raw powder used was a mixture of a Zn ferrite powder and a CuO powder weighed so that the content of the Cu component was 0.3 mol %.

### Example 4

A multilayer electronic component was produced in the same manner as in Example 1, except that the nonmagnetic raw powder used was a mixture of a Zn ferrite powder and a CuO powder weighed so that the content of the Cu component was 0.5 mol %.

### Example 5

A multilayer electronic component was produced in the same manner as in Example 1, except that the nonmagnetic raw powder used was a mixture of a Zn ferrite powder and a CuO powder weighed so that the content of the Cu component was 0.7 mol %.

### Example 6

A multilayer electronic component was produced in the same manner as in Example 1, except that the nonmagnetic raw powder used was a mixture of a Zn ferrite powder and a CuO powder weighed so that the content of the Cu component was 1 mol %.

### Example 7

A multilayer electronic component was produced in the same manner as in Example 1, except that the nonmagnetic raw powder used was a mixture of a Zn ferrite powder and a CuO powder weighed so that the content of the Cu component was 2 mol %.

### Comparative Example 1

A multilayer electronic component was produced in the same manner as in Example 1, except that the nonmagnetic raw powder used was only a Zn ferrite powder without the Cu component.

### Comparative Example 2

A multilayer electronic component was produced in the same manner as in Example 1, except that the nonmagnetic raw powder used was a mixture of a Zn ferrite powder and a CuO powder weighed so that the content of the Cu component was 3 mol %.

The content of the Cu component in the varistor section was measured and calculated with an inductively-coupled high-frequency plasma emission spectrometer (ICP). The resistivity (ρ) of the inductor section was calculated by determining the resistance (R) from a value of an electric current flowing with application of a dc voltage of 1 V to each sample.

The ESD immunity was measured by the electrostatic discharge immunity test defined in the standard IEC61000-4-2 of EC (International Electrotechnical Commission). For the examples, the criterion for the ESD immunity was defined as follows: “o” was determined for sufficient ESD immunity when the immunity was not less than 8 kV; “x” was determined when the ESD immunity was less than 8 kV. The reason why the determination criterion of not less than 8 kV was adopted is that it satisfies level 4 in IEC61000-4-2.

The results of the evaluation are presented in Table 1 below. When the Cu content of the inductor section (ferrite) was within the range of 0.5 mol % to 2 mol %, the results were good for both of the ESD immunity and the resistivity of the inductor section. In Comparative Example 1 where the inductor section did not contain Cu, the resistivity of the inductor section was lowered. For this reason, it is highly likely that satisfactory filter characteristics are not achieved. On the other hand, in Comparative Example 2 where the inductor section contained a large amount of Cu, the Cu content of the varistor section was increased and the ESD immunity was lower than 8 kV.

TABLE 1

| | | Cu | | |
|---|---|---|---|---|
| | Cu component | component | ρ of | |
| | In inductor | In varistor | inductor | |
| | section | section | section | ESD |
| | (mol %) | (ppm) | (Ω · m) | immunity |
| Comparative | 0 | 0 | 3.80E+05 | ◯ |
| Example 1 | | | | |
| Example 1 | 0.05 | 7 | 1.10E+06 | ◯ |
| Example 2 | 0.1 | 14 | 1.70E+06 | ◯ |
| Example 3 | 0.3 | 41 | 1.80E+06 | ◯ |
| Example 4 | 0.5 | 68 | 2.30E+06 | ◯ |
| Example 5 | 0.7 | 75 | 2.70E+06 | ◯ |
| Example 6 | 1 | 135 | 3.20E+06 | ◯ |
| Example 7 | 2 | 270 | 4.90E+06 | ◯ |
| Comparative | 3 | 405 | 8.90E+06 | X |
| Example 2 | | | | |

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A multilayer composite electronic component comprising: an inductor section having a first sintered body and a plurality of coil conductors arranged in the first sintered body; and a varistor section having a second sintered body and a plurality of internal electrodes arranged in the second sintered body, and exhibiting a nonlinear current-voltage characteristic;
wherein the first sintered body and the second sintered body are integrally fired; and
wherein a region of the first sintered body sandwiched between the coil conductors and a region of the first sintered body inside each said coil conductor are comprised of a magnetic material or a nonmagnetic material, and comprise a ferrite material containing a Cu component in an amount of 0.05 mol % to 2 mol % in terms of CuO.

2. The multilayer composite electronic component according to claim 1, wherein the ferrite material is a Ni—Zn ferrite, a Ni—Zn—Mg ferrite, or a Zn ferrite.

3. The multilayer composite electronic component according to claim 1, wherein each said coil conductor consists of a plurality of conductor patterns arranged in a first direction;
wherein the first sintered body has a first layer sandwiched by the conductor patterns in the first direction, and second layers sandwiching the plurality of coil conductors in the first direction, wherein the first layer is comprised of a nonmagnetic material, and wherein the second layers are comprised of a magnetic material.

4. The multilayer composite electronic component according to claim 2, wherein each said coil conductor consists of a plurality of conductor patterns arranged in a first direction;
wherein the first sintered body has a first layer sandwiched by the conductor patterns in the first direction, and second layers sandwiching the plurality of coil conductors in the first direction, wherein the first layer is comprised of a nonmagnetic material, and wherein the second layers are comprised of a magnetic material.

5. The multilayer composite electronic component according to claim 1, wherein each said coil conductor consists of a plurality of conductor patterns arranged in a first direction;
wherein the first sintered body has a first layer sandwiched by the conductor patterns in the first direction, and second layers sandwiching the plurality of coil conductors in the first direction, and wherein the first and second layers are comprised of a magnetic material.

6. The multilayer composite electronic component according to claim 2, wherein each said coil conductor consists of a plurality of conductor patterns arranged in a first direction;
wherein the first sintered body has a first layer sandwiched by the conductor patterns in the first direction, and second layers sandwiching the plurality of coil conductors in the first direction, and wherein the first and second layers are comprised of a magnetic material.

7. The multilayer composite electronic component according to claim 1, wherein each said coil conductor consists of a plurality of conductor patterns arranged in a first direction;
wherein the first sintered body has a first layer sandwiched by the conductor patterns in the first direction, and second layers sandwiching the plurality of coil conductors in the first direction, and wherein the first and second layers are comprised of a nonmagnetic material.

8. The multilayer composite electronic component according to claim 2, wherein each said coil conductor consists of a plurality of conductor patterns arranged in a first direction;
wherein the first sintered body has a first layer sandwiched by the conductor patterns in the first direction, and second layers sandwiching the plurality of coil conductors in the first direction, and wherein the first and second layers are comprised of a nonmagnetic material.
